(19) United States
(12) Patent Application Publication
(10) Pub. No.: US 2012/0237326 A1
(43) Pub. Date: Sep. 20, 2012

(54) SYSTEM AND METHOD FOR TRANSFERRING A WHEELED LOAD INTO A TRANSPORT VEHICLE

(75) Inventor: Doris Van Ness, Bedrock, CO (US)

(73) Assignee: MONTROSE INNOVATIONS, LLC, Bedrock, CO (US)

(21) Appl. No.: 13/409,586

(22) Filed: Mar. 1, 2012

Related U.S. Application Data
(60) Provisional application No. 61/453,466, filed on Mar. 16, 2011.

(51) Int. Cl. A61G 3/06

(52) U.S. Cl. 414/507; 414/812

(57) ABSTRACT

A simple, adjustable lift system to load a cot bearing a patient into and out of an ambulance and a method of transferring a load on a transport into a vehicle is provided. More specifically, the lift system provides a pair of rails that may be adjusted to accommodate any cot currently in use by an ambulance. The rail system is extendable and is operated by a linear actuator to couple to a cot or other transport and lift the cot or other transport to a height from which the cot may be laterally inserted into the ambulance without undue strain on the EMT, firefighter, or other user.

### CROSS REFERENCE TO RELATED APPLICATIONS

This application claims the benefit of U.S. Provisional Patent Application No. 61/453,466, entitled “SYSTEM AND METHOD FOR TRANSFERRING A WHEELED LOAD INTO A TRANSPORT VEHICLE” filed on Mar. 15, 2011, the entire disclosure of which is incorporated by reference herein.

### FIELD OF THE INVENTION

This invention relates to an ambulance cot loading and unloading device and methodology, as well as an ambulance cot support arrangement, especially suitable for ambulances. While the invention has particular use with cots in ambulances, other systems of wheeled cargo are also envisioned.

### BACKGROUND OF THE INVENTION

The use of cots or stretchers generally includes resting the stretcher on the ground at a minimum height to allow simplified manual transfer of a sick or injured person or patient onto the stretcher, and then raising the stretcher with the sick or injured person or patient on it up to a height similar to that of the loading plane of the ambulance. The sick or injured person or patient in the cot is then loaded into the ambulance in order to transport the sick or injured person or patient to the hospital, where the stretcher will once more have to be unloaded from the ambulance, hopefully without causing trauma or jolts to the sick or injured person or patient. Ambulances use stretchers that are made and equipped to facilitate this procedure. Still, however, current practice requires the operators of the ambulance to physically bear the weight of the stretcher with the sick or injured person or patient on it. Increasingly, this weight means that the operators are subjected to a considerable physical strain. For a general background on ambulance cots and loading/unloading procedures, see U.S. Pat. No. 7,520,551 issued Apr. 21, 2009, U.S. Patent Application Publication No. 2006/0181100 published Aug. 17, 2006, and U.S. Patent Application Publication No. 2008/0290679 published Nov. 27, 2008, each of which are incorporated by reference in their entireties.

Some stretchers known as “self-loading” are known, which comprise a rest plane for receiving and securing the patient in a lying position. The stretcher plane has at least two support legs that allow the stretcher to alternate between a height near the ground and a height that is approximately the same height as the loading plane of the ambulance.

Often, a spring-activated system enables the legs to open automatically, but only after the stretcher has been physically raised from the ground through the efforts of the operators. The raising operation therefore must be performed manually by at least two operators, who have to bend over in order to grip the stretcher and thus have to raise it by brute force before the support legs can be opened. As the raising of the stretcher is done after the sick or injured person or patient has been transferred onto the stretcher, this operation often represents a great strain and can lead to serious injury to the health operators performing it.

In order to alleviate this effort, stretchers for ambulances have been designed with and are provided with a motorised system for raising the stretcher on which the sick or injured person or patient is lying. A variety of such stretchers are currently on the market with various designs, each having their respective advantages and disadvantages. Private and public emergency service providers have in some instances invested significant funds to provide these specialized cots for their emergency response personnel. However, during the stages of loading and unloading the stretcher to and from the ambulance, the automatic carriage system must be kept in a retracted configuration, such that it cannot provide any rest support for the stretcher, the weight of which must therefore be physically supported by the health operatives.

The prior art typically are specialized to one particular cot manufacturer and/or require extensive impracticable ambulance mechanisms, require a loaded cot that rests at unacceptably high positions, or do not relieve the operator from lifting or maneuvering the majority of the cot/patient weight during loading or unloading.

For example, U.S. Pat. No. 6,332,638 to Menna (“Menna”) issued Dec. 25, 2001 discloses an apparatus for loading stretchers into an ambulance. The Menna device includes a loading table for the front end of the stretcher bed portion and by which the stretcher is transferred into the ambulance. The loading table is positioned with its rear edge in a position projecting outwards from the rear surface of the ambulance; an auxiliary device applied to the rear edge of the loading table has a horizontal abutment element positioned at a height lower than the rear end of the upper surface of the loading table in order to engage the front legs of the stretcher. The Menna device results in a loaded cot that sits awkwardly high within the ambulance. Menna is incorporated by reference in its entirety.

U.S. Patent Application Publication No. 2010/0045059 to Bourgraf et al. (“Bourgraf”) published Feb. 25, 2010 discloses a combination cot loading and fastening system for loading and unloading an ambulance cot. The Bourgraf device requires a pair of tracks, a shuttle assembly to securely pull the ambulance cot along the pair of tracks, and a locking mechanism mounted on the shuttle assembly. The shuttle assembly is configured to position the locking mechanism a distance away from a second end of the pair of tracks and at angle below the transport deck of the emergency rescue vehicle, the angle ranging from about 10° to 25°, and the distance ranging about 22.8 centimeters (about 9 inches) to about 50 centimeters (about 20 inches). Bourgraf is specialized to particular cots and ambulances. Bourgraf is incorporated by reference in its entirety.

U.S. Pat. No. 6,916,056 to Mitchell et al. (“Mitchell I”) issued Jul. 12, 2005 and U.S. Pat. No. 7,111,340 to Mitchell et al. (“Mitchell II”) issued Sep. 26, 2006 disclose a bariatric gurney and process including a winch mounted in an ambulance for pulling the gurney up removable rails. The gurney includes extenders for increasing the patient support surface of the gurney and may include a removable patient safety bar. No rail support is provided. Further, Mitchell requires elaborate lashing of components to engage a winch, a time-consuming process that undoubtedly would introduce many pinch-points for the users and the patient. Mitchell I and Mitchell II are incorporated by reference in their entireties.

U.S. Pat. No. 7,478,855 to Lambarth et al. (“Lambarth”) issued Jan. 20, 2009 discloses an ambulance cot loading and unloading device which uses an elongate guide track configured for mounting to a floor surface of a cargo area on an ambulance. A trolley is supported for movement relative to the guide track and has an elongate boom. The ambulance cot has a powered collapsible and extendable base and a patient support deck mounted on the base. A connection mechanism is provided on the trolley and the ambulance cot which is configured to interconnect and securely hold the ambulance cot on the trolley. Lambarth is specialized to one cot design and requires the user to lift and maneuver the cot/patient weight during loading or unloading. Lambarth is incorporated by reference in its entirety.

Notwithstanding this significant investment, then, the operation of loading and unloading a cot with a sick or injured person or patient in it is very laborious and can cause serious physical injuries to the operatives doing it. Emergency medical service (EMS) personnel (or Emergency Medical Technicians “EMT”s) are required to handle the combined weight of the ambulance cot and the sick or injured person or patient during various stages of insertion of the ambulance cot into the cargo area of an ambulance. In some instances, there exists a risk of back injury to the EMS personnel as a result of this lifting and insertion as well as removal methodology. In addition, there is a risk of injury to the sick or injured person or patient on the ambulance cot when an EMS attendant is injured and is no longer able to support the ambulance cot when the ambulance cot is spaced above the ground during insertion or removal from the cargo area of the ambulance.

Current practices of loading a cot into an ambulance are cumbersome, expensive, and require a specialized cot for use with the loading and unloading device. Lift systems in the art employ complicated coupling and lifting mechanisms that cannot be employed on cots currently in use in an ambulance. Such systems can cost tens of thousands of dollars and require a duplicate investment by requiring emergency service providers to replace functional cots or stretchers with specialized cots that will work with the lift system. There is, among other needs, a need for a simplified system that will function with a wide variety of existing cot structures.

The prior art devices and methods of use do not adequately provide a reliable, effective, cost-effective means to relieve the operator from lifting or maneuvering the majority of the cot/patient weight during loading or unloading, so as to not be specialized to one particular cot manufacturer and/or do not require extensive or impracticable ambulance mechanisms or require a loaded cot that rests at unacceptably high positions. Therefore, there is a long-felt need for an apparatus and method that solves these needs. The present invention solves these needs by providing a device and method of use that relieves the operator from lifting or maneuvering the majority of the cot/patient weight during loading or unloading and is adaptable to cot configurations and geometries.

### SUMMARY OF THE INVENTION

The present invention provides among other things a simplified, inexpensive, adjustable patient transport lift system and a method of transferring a load on a transport into a vehicle. More specifically, the lift system provides a pair of rails that may be adjusted to accommodate any cot currently in use by an ambulance. The rail system is extendable and is operated by a linear actuator, a winch, a spring system or some combination to couple to a cot or other transport and lift the cot or other transport to a height from which the cot may be laterally inserted into the ambulance without undue strain on the EMT, firefighter, or other user.

The phrase “device” and/or “apparatus” and/or “rail list” is used herein to indicate the invention device. The phrase “automatic” refers to a device's ability to automatically adjust and/or adapt itself to maintain and/or monitor a specified condition or state. The phrase “removably attached” and/or “detachable” is used herein to indicate an attachment of any sort that is readily releasable. As used herein the terms “person” and “patient” are used interchangeably. The invention is not limited to transport of a person or patient, and may extend to a system and method of transporting other cargo.

It is an object of the invention to provide a lift system that prevents undue strain on EMT and other personnel charged with loading a load on a transport into a vehicle. It is another object of the invention to provide a simple linear actuator mechanism to load a cot onto an ambulance. It is another object of the invention to provide a lift mechanism that may be adjusted for use with existing cots used in ambulances in the industry. It is another object of the invention to provide a method for safely and securely transferring a load on a transport into a vehicle by lifting the load with a linear actuator system to a height sufficient to laterally insert the transport into the vehicle.

The above and other objects may be achieved using devices involving a lift system for use in loading a cot into and unloading a cot from an interior of an ambulance. The cot may be any cot currently in use having a head end, at least one load wheel, and a support frame. The lift system employs a rail coupled to the ambulance by a brace and further coupled to the ambulance at an axle that allows the rail to pivot. A linear actuator, winch, spring, or combination is also coupled to the ambulance and to the brace. The linear actuator, winch, spring, or combination is mechanically operated to vary the distance of the brace from the ambulance. The rail has an extension that may be extended from the length of the rail. An interface hook that may be detachably coupled to the support frame is coupled to the rail extension, typically near the end of the extension, so that movement of the brace pivots the extension to place at least a portion of the weight of the cot on the interface hook.

In one embodiment, the system includes a first and a second rail coupled to the ambulance at a brace and an axle. The brace, the axle, or both the brace and the axle may each be a single structure that spans the gap between the first rail and the second rail. The gap between the first rail and the second rail may be adjustable to accommodate any sized cot support frame. The axle of the rails may be supported on a leg that is adjustable with respect to its position relative to the floor of the ambulance. The leg may be adjusted in a direction perpendicular to the alignment of the rails, to allow the width between the rails to be customized.

Each rail is extendable, and has an interface hook to interact with the support frame of the cot. In a particular embodiment, the second interface hook is coupled to the cot support frame opposite to the first interface hook. The interface hook may be a generic hook that can accommodate a variety of support frames, or may be configured to form a partial or complete sleeve of a portion of a particular support frame. The linear actuator in the system is typically a motorized jack, that may, or may not, be supplemented by a spring system.

Leverage of the rail system about the pivot point may be increased by placing the actuator at a greater distance from the end of the ambulance where the cot is loaded into the ambulance. Typically, this means the linear actuator is placed near the driver's cab of the ambulance.

The above and other objects may be achieved using methods involving lifting a load on a transport into and out of a vehicle. The vehicle will have an interior floor at some height, and the transport will have a carriage, usually with wheels to allow movement of the transport, and a support frame. An extendable rail is provided that may be completely enclosed in the interior of the vehicle when the vehicle is in motion. The rail is coupled to the vehicle at a brace and an axle. The extension of the extendable rail may be detachably coupled to the transport, typically at the support frame. The rail is extended outside of the vehicle, and the brace is moved to pivot the rail about the axle. In one embodiment, the brace is coupled to the interior floor of the vehicle and is moved in direction substantially away from the interior floor of the ambulance. As the brace is moved up, the opposite end of the rail is pivoted down below the level of the interior floor of the ambulance. The extendable rail may be coupled to the transport without lifting the transport prior to coupling.

Once the transport is coupled to the rail, the brace is moved in the opposite direction, which may be back toward the interior floor of the ambulance. The rail is again pivoted about the axle, lifting the transport so that the carriage is at or slightly above the level of the interior floor of the vehicle. The transport may then be laterally inserted into the vehicle by collapsing the extendable rail.

In another embodiment, two rails are provided having a gap between the rails, and the gap between the rails is adjusted to accommodate a specific transport or transport support frame.

By way of providing additional background, context, and to further satisfy the written description requirements of 35 U.S.C. §112, the following references are incorporated by reference in their entireties for the express purpose of explaining the nature of the devices and methods used to load and unload cots and to further describe the various tools and other apparatus commonly associated therewith: U.S. Pat. No. 3,831,996, U.S. Pat. No. 5,022,105, U.S. Pat. No. 5,253,973, U.S. Pat. No. 5,785,277, U.S. Pat. No. 6,024,528, U.S. Pat. No. 6,916,056, U.S. Pat. No. 7,111,340, U.S. Pat. No. 7,140,055, U.S. Pat. No. 7,328,926, U.S. Pat. No. 7,398,571, U.S. Pat. No. 7,540,547, U.S. Pat. No. 7,520,551, U.S. Pat. No. 7,636,961, U.S. Pat. No. 7,637,550, U.S. Patent Application Publication No. 2010/0045059 and British Patent No. GB2468604.

Incorporated herein by this reference are various patents and patent publications that one of skill in the art will appreciate can be used in conjunction with the teaching and guidance provided herein to perform particular operations on various devices and in varying conditions. For the purposes of brevity while still complying with written description and enablement requirements, the following are hereby incorporated herein by this reference in their entireties: U.S. Patent Application Nos. 2011/0080016, 2011/0198877, 2011/0265262, 2011/0121149 and 2011/0265303. Also hereby incorporated herein by this reference in their entireties are the following: U.S. Pat. No. 6,540,271 and U.S. Patent Application Nos. 2011/0175324, 2011/0223459, 2012/0036785, 2011/0198870, 2011/0179684 and 2011/0133492.

In another embodiment of the invention the device includes a cot clamp device. The cot clamp device comprises a cot clamp device lateral frame, cot clamp device left frame, cot clamp device left arm, cot clamp device left arm proximal lower member, cot clamp device left arm flare and cot clamp device frame/arm angle. The cot clamp device further comprises a cot clamp device frame, cot clamp device left arm and cot clamp device right arm. Also, the cot clamp device frame includes a cot clamp device right frame and cot clamp device left frame. The cot clamp device right arm includes a cot clamp device right arm proximal upper member, a cot clamp device right arm proximal lower member, one or more cot clamp device right arm holes and cot clamp device right arm flare. The cot clamp device left arm comprises a cot clamp device left arm proximal upper member, one or more cot clamp device left arm holes and cot clamp device left arm flare. The cot clamp device right arm is configured to align with cot clamp device right side cot mechanism, that is the one or more cot clamp device right side cot mechanism holes may be aligned with the one or more cot clamp device right side cot mechanism holes. Similarly, the cot clamp device left arm is configured to align with cot clamp device left side cot mechanism, that is the one or more cot clamp device left side cot mechanism holes may be aligned with the one or more cot clamp device left side cot mechanism holes.

In one embodiment, the cot clamp device frame is of a squared U-shape such that the cot clamp device lateral frame forms right angles with each of the cot clamp device right frame and cot clamp device left frames. In another embodiment, the shape is any known in the art to provide stability and conform to the geometries of the other structures of the device, for example, a shape such that the corners are not right angles but instead 45 degree angles.

The cot clamp device right side cot mechanism comprises a cot clamp device right side cot mechanism arm, cot clamp device right side cot mechanism proximal end and cot clamp device right side cot mechanism distal end. The cot clamp device right side cot mechanism is fitted with one or more cot clamp device right side cot mechanism holes. The cot clamp device right side cot mechanism is fitted with one or more cot clamp device right side cot mechanism bodies, each of which comprise a cot clamp device right side cot mechanism body face and cot clamp device right side cot mechanism hole. In one embodiment, the cot clamp device right side cot mechanism is configured with three sets of cot clamp device right side cot mechanism bodies, cot clamp device right side cot mechanism body face and cot clamp device right side cot mechanism hole. The cot clamp device right side cot mechanism is fitted with one or more cot clamp device right side cot mechanism attachments. In one embodiment, each cot clamp device right side cot mechanism comprises four cot clamp device right side cot mechanism attachments, each configured as a bolt.

In one embodiment, the cot clamp device right side cot mechanism is of rectilinear profile. In another embodiment, the profile shape is any known in the art to provide stability and conform to the geometries of the other structures of the device and to enable affixing to the cot, for example, a triangle profile.

In another embodiment of the invention the device includes an alternate embodiment of the cot clamp device. The cot clamp device employs a modified and specially-adapted door latch mechanism comprising a door striker receiving cavity, door latch receiving mechanism and door latch mounting plate. The door latch engages a door striker as the two move relative to one another such that the door striker enters the door striker receiving cavity so as to engage the door latch receiving mechanism. In this embodiment of the cot clamp device, the cot clamp device right side cot mechanism, cot clamp device left side cot mechanism and cot clamp device pin are replaced with a door latch and door striker on one or both of cot clamp device left arm and cot clamp device right arm. More specifically, cot clamp device right arm comprises a cot clamp latch right side, cot clamp latch right side wire and cot clamp latch right side handle. Similarly, cot clamp device left arm comprises a cot clamp latch left side, cot clamp latch left side wire and cot clamp latch right side handle. A door striker is fitted to a cot so as to engage one or more of cot clamp latch right side and cot clamp latch left side. The cot clamp latches are adapted to be oriented substantially perpendicularly to the respective cot clamp device right arm and cot clamp device left arm, and the respective door strikers are fitted to the cot. When the door strikers engage any of the cot clamp latch right side and/or cot clamp latch left side, the cot is secured to the cot clamp device. To disengage the door strikers, cot clamp latch handles are engaged/pulled/lifted so as to communicate via cot clamp wires so as to disengage the one or more door strikers with the one or more of cot clamp latch right side and cot clamp latch left side.

In one embodiment, the base plate is other than one piece. In another embodiment, the base plate is replaced by smaller plates only at the attachment points, for example by 6 inch square plates and the location(s) of the axle and/or below or near the lift mechanism.

In one embodiment, the lift mechanism is a winch. In another embodiment, the list mechanism is any mechanical device that is used to pull in (wind up) or let out (wind out). In one embodiment, the winch comprises a gear assembly, is powered by any of electric, hydraulic, pneumatic or internal combustion drives, includes a solenoid brake and/or a mechanical brake or ratchet and pawl device that prevents it from unwinding unless the pawl is retracted.

In one embodiment, the cot clamp device cot mechanism and/or cot clamp device and/or either one or both of the cot clamp device right side cot mechanism and the cot clamp device left side cot mechanism, are any means known to one skilled in the art for clamping. Such means include C-clamps, Velcro™ and other hook and eye fasteners, belts and cords. Suitable cot attachment member configurations include, but are not limited to, flanges, G-clamps and the like; and wherein the attachment members can be secured to components of a medical cot by various methods in including, but not limited to bolting, clamping, welding, riveting and the like as well as combinations thereof. In certain embodiments the cot clamp device cot mechanism and/or cot clamp device and/or either one or both of the cot clamp device right side cot mechanism and the cot clamp device left side cot mechanism is attachable to a frame rail of the cot while in certain other embodiments the cot clamp device cot mechanism and/or cot clamp device and/or either one or both of the cot clamp device right side cot mechanism and the cot clamp device left side cot mechanism is attachable to a side rail of the cot. In still other embodiments the cot clamp device cot mechanism and/or cot clamp device and/or either one or both of the cot clamp device right side cot mechanism and the cot clamp device left side cot mechanism is an integral element of a cot component such as a frame rail or side rail.

Embodiments of the present invention provide an adjustable apparatus, which is attachable to a medical emergency cot, gurney, wheeled stretcher, medical bed, medical chair or the like to support and immobilize an extremity of a human body, i.e. limb, during transport of a patient.

A cot clamp device pin is configured for insertion into the one or more cot clamp device right arm holes, the cot clamp device left arm holes, the one or more cot clamp device right side cot mechanism holes and the one or more cot clamp device left side cot mechanism holes. In one embodiment, the cot clamp device pin is configured as a pin with substantially perpendicular head. In another embodiment, the cot clamp device pin comprises a dowel, a bolt, a peg and rod.

One or ordinary skill in the art will appreciate that embodiments of the present disclosure may be constructed of materials known to provide, or predictably manufactured to provide the various aspects of the present disclosure. These materials may include, for example, stainless steel, titanium alloy, aluminum alloy (such as 6061 Aluminum), chromium alloy, and other metals or metal alloys. These materials may also include, for example, PEEK, carbon fiber, ABS plastic, polyurethane, rubber, latex, synthetic rubber, and other fiber-encased resinous materials, synthetic materials, polymers, and natural materials.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. Applicants further express that if the provisions of 35 U.S.C. §112 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function.

In other embodiments, various elements of the device may be fitted with an abrasive or otherwise gripping material or gripping means to assist in the secure engagement of the element of the device to another member or to the cot. Such abrasive material may include a rubber material and/or a sand-paper-like material.

One of ordinary skill in the art will appreciate that embodiments of the present disclosure may be controlled by means other than manual and/or mechanical and/or hydro-mechanical manipulation. Embodiments of the present disclosure may be designed and shaped such that the apparatus may be controlled, for example, remotely by an operator, remotely by an operator through a computer controller, by an operator using proportioning devices, programmatically by a computer controller, by servo-controlled mechanisms, by pneumatically-driven mechanisms, by piezoelectric actuators.

In one embodiment of the invention, the device is fitted with one or more active and/or passive sensors for qualitative and/or quantitative sensing of mechanical, electrical, physical, and/or chemical quantities, to detect, for example, position of the cot and weight of the cot (with and/or without a patient). Such sensors can be selected in particular from the group of timers, infrared sensors, brightness sensors, temperature sensors, motion sensors, elongation sensors, rotation speed sensors, proximity sensors, color sensors, gas sensors, vibration sensors, pressure sensors, conductivity sensors, turbidity sensors, acoustic pressure sensors, “lab on a chip” sensors, force sensors, acceleration sensors, tilt sensors, moisture sensors, magnetic field sensors, RFID sensors, magnetic field sensors, Hall sensors, biochips, odor sensors, hydrogen sulfide sensors, and/or MEMS sensors, as well as simpler sensors such as a tilt switch, pressure switch, or contact switch. In one embodiment, the sensors are conveyed as control signals to a control unit.

In one embodiment of the invention, the device is fitted with enhanced safety features, comprising lights, reflectors, warning labels and devices, and any device known to one skilled in the art to enhance safety of operations involving cots and related emergency care, in particular emergency care as related to loading and unloading of patients via cots into and out of ambulance vehicles.

In another embodiment, the user is alerted to a selectable instability or over-weight condition of the device by any means known to those skilled in the art. For example, the alert (or alarm or indication) could be communicated to a user by any one or combination of means, to include audio, vibration, thermal, mechanical such as actuation of a piston or lever, electrical, fluid, pneumatic, visual such as a steady or blinking light, magnetic, hydro-mechanical, and/or electro-mechanical such as through use of piezoelectric transducers, linear variable differential transformers and/or rotary variable differential transformers.

In another embodiment, the frame attaches to the floor mount plate on a pivot point on each side. At the top, middle and bottom of the frame are pre-drilled holes with a slide adjustment so the frame can be changed to different widths to accommodate different widths of cots. The device will have two carriages on each arm, each arm will have the capability of carrying 1120 lbs. each, with a total capability of 2240 lbs. In one embodiment, the device will comprise Victor Quad, Linear Guide VQ 3, which will attach to the top of the frame. Each corner and the middle of the frame will have braces that are approximately 3 inches long. Such features will, among other things, ass stabilization for the device.

In another embodiment, the slide that attaches to the frame will have the same adjustment for different widths of cot only at the top, and will have braces in each corner for added stabilization. The slide will attach to the Frame and telescope out from the bottom to the top. Brackets will attach at four points two on each arm that attach to the cot. This embodiment is a self leveler so as the cot is raised it levels out to keep the cot at the same angle. In one particular embodiment, the cots are at about 20 degree angle when in the highest position.

In one embodiment, the device conforms to U.S. government standards, comprising those of KKK-A-1822.

This Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention, and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the Detailed Description of the Invention, the drawing figures, and the exemplary claim set forth herein, taken in conjunction with this Summary of the Invention, define the invention.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures. In the figures, like reference numbers refer to like elements or acts throughout the figures. Elements and acts in the figures are illustrated for simplicity and have not necessarily been rendered according to any particular sequence or embodiment.

FIG. 1 depicts an overhead view of one embodiment of the transport patient lift system of the invention.

FIGS. 2 and 2A depict a side view of the embodiment of FIG. 1 with the linear actuator compressed and extended, respectively.

FIGS. 3A-3E depict the transport patient lift system of FIG. 1 in various states of operation.

FIG. 4 depicts close up perspective view of the rail extension sliding mechanism of the embodiment of FIG. 1.

FIG. 5 depicts a close up perspective view of the brace and lift mechanism of the embodiment of FIG. 1.

FIG. 6 depicts a cot adapted with a coupling hook of the present invention.

FIGS. 7A-7E depict an alternative embodiment of the transport patient lift system interacting with an ambulance.

FIG. 8 is a close up perspective view of the end of the rail extension of FIG. 1.

FIG. 9A depicts a side view of the cot clamp device;

FIG. 9B depicts a top view of the cot clamp device;

FIG. 9C depicts a top-view of the cot clamp device attachment mechanism;

FIG. 9D depicts a side-view of the cot clamp device attachment mechanism;

FIG. 9E depicts a cross-sectional view of the cot clamp device attachment mechanism along section A-A;

FIG. 9F depicts a cot clamp device pin of the cot clamp device;

FIG. 10A depicts a side view of an alternate embodiment of the cot clamp device mechanism;

FIG. 10B depicts a side view of a vehicle door latch of the prior art;

FIG. 10C depicts a top view of an alternate embodiment of the cot clamp device;

Example A illustrates a particular embodiment of the invention; and

Example B illustrates a particular embodiment of the invention.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

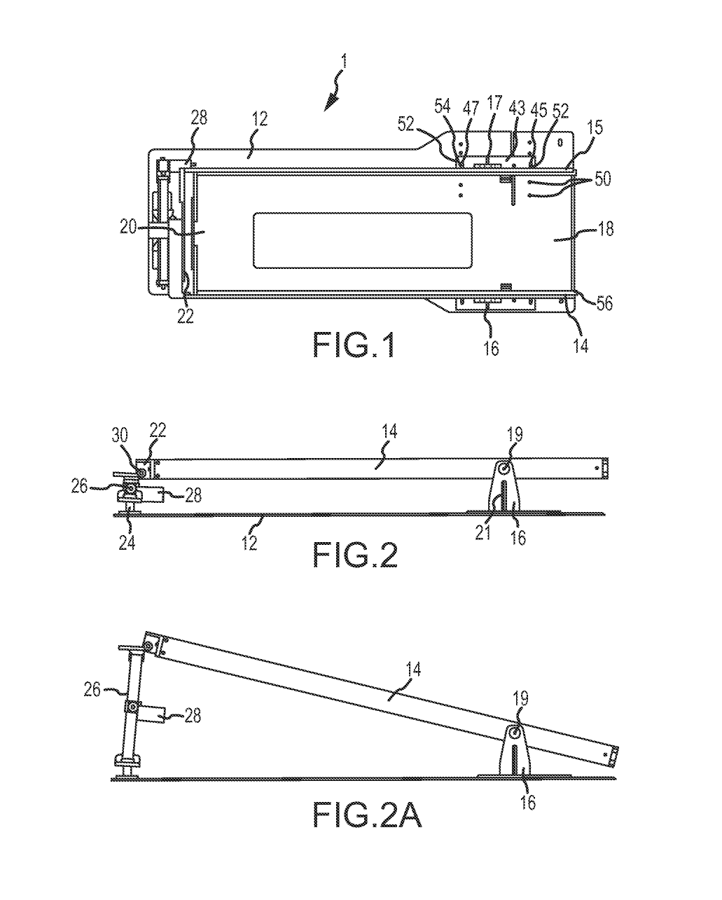

Referring now to FIGS. 1-10, several representations and configurations of the present invention are shown.

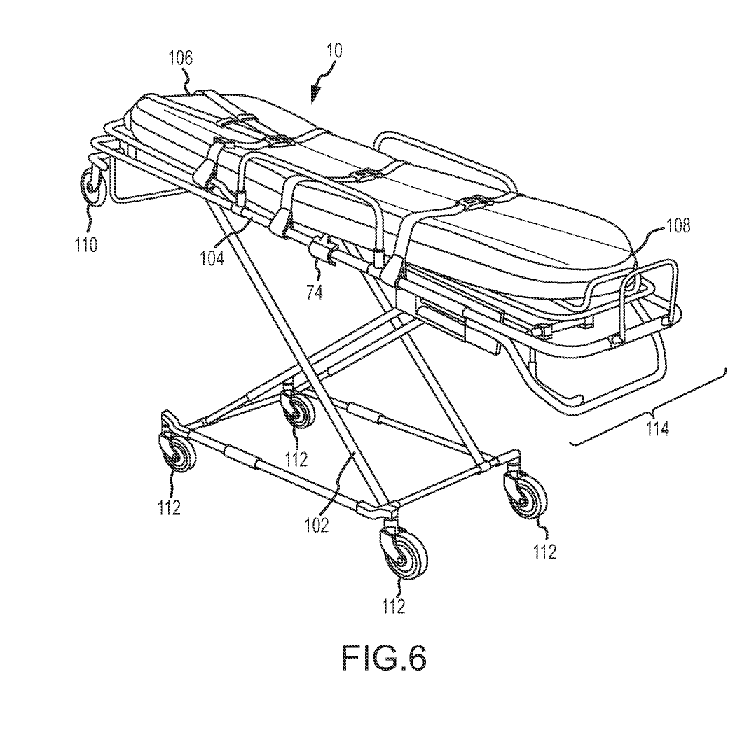

In one application of the invention, a device 1 for loading a cot 10 into an ambulance is provided. The device 1 may be added to any sized ambulance to assist in loading and unloading a cot 10 in an ambulance. While ambulance cots 10 are provided in a number of shapes and designs, some elements are nearly universal. As shown in particular in FIG. 6, an ambulance cot 10 includes a foldable wheel carriage 102 beneath a support frame 104. Cot is configured to have a head end 106 and a feet end 108. The cot 10 is introduced into an ambulance with the head end 106 leading the feet end 108. Load wheels 110 rest on the floor of the interior of the ambulance and support at least a portion of the weight of the cot 10 as the wheel carriage 102 is folded beneath the cot 10. Currently, the EMT or firefighter or other emergency response personnel is required to support the remaining weight of the cot 10 and patient as the wheel carriage 102 is folded. The EMT or firefighter must then lift the cot 10 into a position substantially parallel to the interior floor of the ambulance and push the patient and the cot 10 into the ambulance. The load wheels 110 in conjunction with the transport wheels 112 facilitate complete entry of the cot into the ambulance.

Referring now to FIG. 1, in one embodiment, the device includes a base plate 12 to secure the device to the floor of the interior of the ambulance. Rails 14, 15 are coupled by an axle 19 to legs 16, 17. The legs 16, 17 are then securely coupled to the base 12. Alternatively, the axle 19 may be more closely coupled to the base 12 and the legs 16, 17 may span a distance between the axle 19 and the rails 14, 15. Rails 14, 15 form au-shaped structure with an open end 18 and a closed end 20. A brace 22 spans the gap between the rails 14, 15 at the closed end 20. The shape of the rails 14, 15, or the brace 22 may be shaped to accommodate existing safety structures used to secure the cot 10 in an ambulance. The device 1 may be made of any suitable material. In a particular embodiment, the device 1 is composed of a powder coated steel/aluminum framework with precision hardened stainless-steel rails 14, 15.

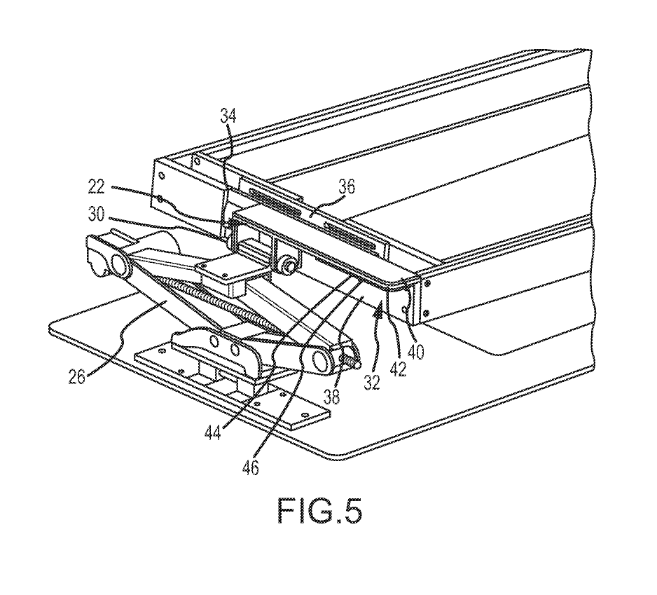

Brace 22 is coupled to a lift mechanism 24. Referring in particular to FIG. 5, the lift mechanism 24 may be a linear actuator 26. The linear actuator may include, but is not limited to, a mechanism such as a screw jack, a ball screw or roller screw actuator, a hoist, winch, rack and pinion, chain drive, belt drive, rigid chain or rigid belt actuator, a cam actuator, or a hydraulic, pneumatic, piezoelectric or electro-mechanical actuator. In a particular embodiment, the linear actuator is a screw-driven jack operated by an electronic motor 28. In another embodiment, the linear actuator is a winch coupled to the brace 22. In yet another embodiment, the linear actuator 26 is a spring system such as those commonly employed in opening a garage door. Alternatively, a spring system may be employed to supplement the actuation force of a jack or the pulling force of a winch to allow use of a less powerful motor 28 to operate the jack or winch. In one embodiment, the motor is a 115 VAC, ⅓ HP motor coupled to a screw driven jack. In another embodiment, the motor 28 is a 1.5 HP 12VDC motor coupled to a utility winch, which is coupled to the brace 22 by a wire or strap.

As the motor 28 turns, the linear actuator 26 provides a linear thrust force to the brace 22 to provide the necessary force to lift (or lower) a loaded cot 10. In the case of a winch system, the motor 28 allows the wire or strap 29 to extend and gravity allows the extended rails 14, 15 to lower toward the ground. Operating the motor 28 in the opposite direction retracts the wire or strap 29 and the extended rails 14, 15 are leveraged about the axle 19, and lifted to a desired height level. The motion of the lift mechanism 24 should be fluid, and capable of lifting or lowering a loaded cot 10 in under approximately 30 seconds.

In one embodiment, linear actuator 26 is coupled to the brace 22 by hinge 30. Hinge 30 together with axle 19 allows the angle of the generally straight rails 14, 15 to change relative to the base plate 12 and the linear actuator 26 as the closed end 20 is lifted by the linear actuator 26. The hinge 30 and the axle 19 may be large aluminum-bronze bearings capable of repeatable motion at low rpm with little maintenance. As one having skill in the art will appreciate, many alternative mechanisms may be used to lift the closed end 20 from the base plate 12.

Brace 22 may have a fixed width or may have an adjustable width. Referring again in particular to FIG. 5, in one embodiment, the brace comprises a first plate 32 coupled to the first rail 14, a second plate 34 coupled to the second rail 15 and a third plate 36 coupled to both the first plate 32 and the second plate 34. The first plate 32 has an L shape with a vertical portion 38 and a horizontal portion 40. Horizontal portion 40 is coupled to the lift mechanism 24. Vertical portion 38 includes a slot 42. Slot 42 may be a straight slot with parallel edges, or may be shaped to allow the width between the rails 14, 15 to be adjusted to pre-determined settings. A bolt 44 with an adjusting nut 46 passes through the slot 42 and is coupled to the third plate 36. When the adjusting nut 46 is loosened, the first plate 32 may be moved relative to the third plate 36. The bolt 44 slides in the slot 42 to increase or decrease the total length of the brace 22, and the corresponding width between the rails 14, 15. When the space between the rails 14, 15 is the desired width, the adjusting nut 46 is tightened to secure the bolt 44 in place in the slot 42, fixing the length of the brace 22. Alternatively, the second plate 34 or the first and second plates 32, 34 may have a slot and be coupled to the third plate 36 to allow movement of the first plate 32, the second plate 34, or both relative to the third plate 36. The brace 22 may be shaped to accommodate a portion of the support frame 104 of the cot 10 to secure the cot 10 in the device during transport.

Referring to FIGS. 1-2, the legs 16, 17 support the axle 19 and are sized to allow the rails 14, 15 to lie parallel to the floor of the ambulance or other vehicle in which the device 1 is installed when the lift mechanism 24 is at its rest, or loaded, setting. In one embodiment, the legs 16, 17, are quite long, and the rails 14, 15 are positioned near the roof or ceiling of the interior of the ambulance. Alternatively, legs 16, 17 may support the rails 14, 15 and span a distance between the axle 19 and the rails 14, 15. Legs 16, 17 may include a stabilizer 21. When the brace has an adjustable width, the legs 16, 17 are also coupled to the base 12 in a manner which allows the distance between the rails 14, 15 to be adjusted. In one embodiment, at least one of the legs 16, 17 are coupled to the base 12 by an adjustment support 43. Adjustment support 43 is an extension, preferably of metal, lying substantially parallel to the plane of the base 12. The adjustment support 43 may be integral to the at least one leg 16, 17, or may be mechanically coupled to the at least one leg 16, 17.

Adjustment support 43 includes two base slots 45, 47 situated with the at least one leg 16, 17 evenly spaced between the base slots 45, 47. A series of holes 50 are in the base plate 12 aligned with the base slots 45, 47. Base bolts 52 pass through the base slots 46, 47 and into a hole 50. A base adjustment nut 54 may then fasten the adjustment support 43 in place relative to the base 12. Alternatively, the holes 50 may be threaded and the base bolts 52 may include a head that secures the adjustment support 43 in place when the base bolt 52 is screwed into the holes 50 in the base 12. The length of each base slot is slightly less than the space between adjacent holes 50, to allow a full range of movement of the at least one leg 16, 17 relative to the base 12. As one having skill in the art would recognize, there are several alternative methods of adjusting the position of the legs 16, 17 relative to the base plate 12 or the ambulance.

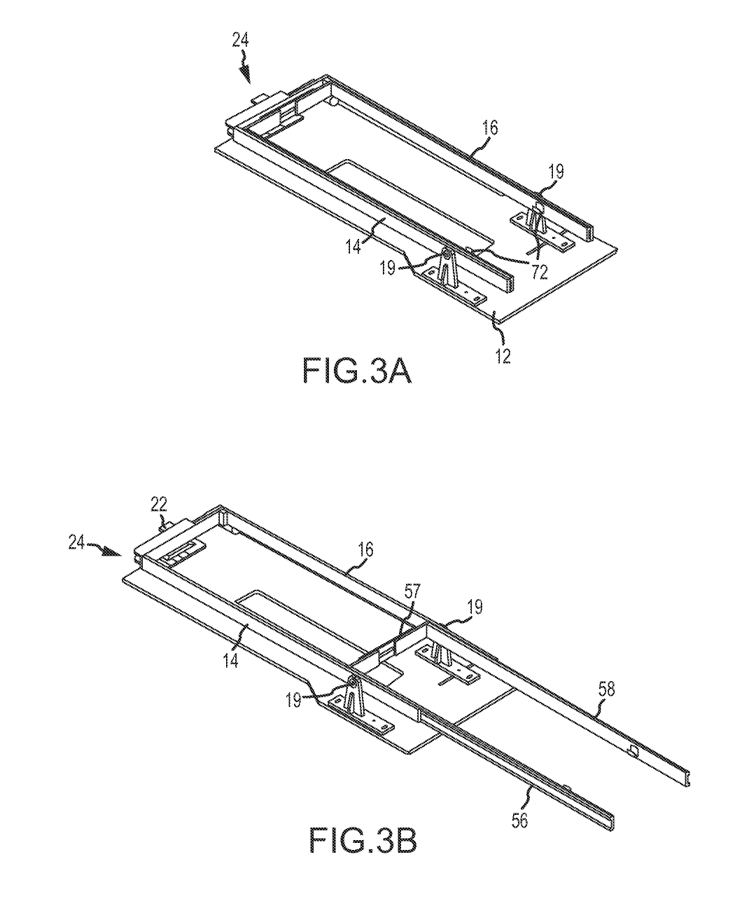

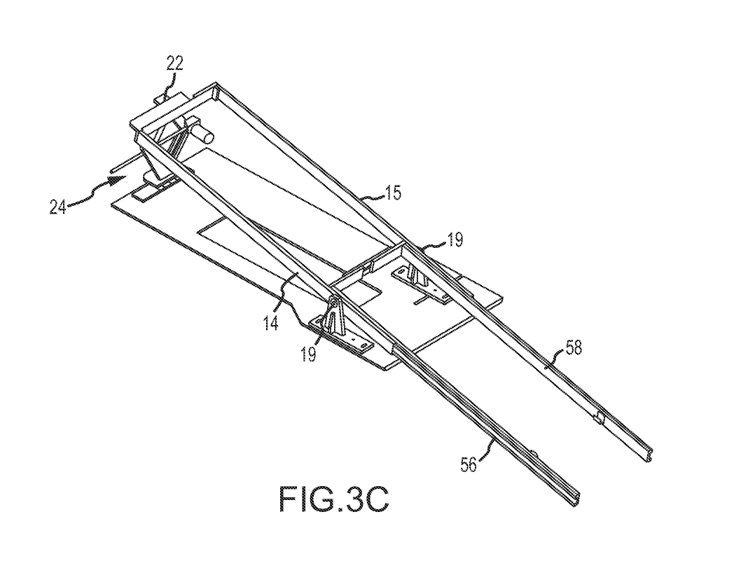

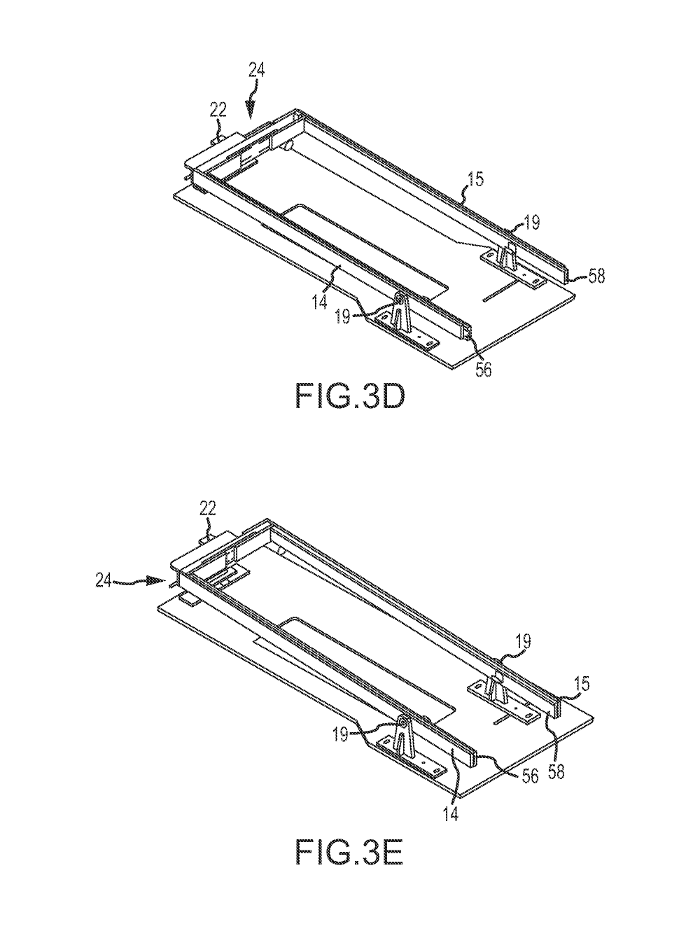

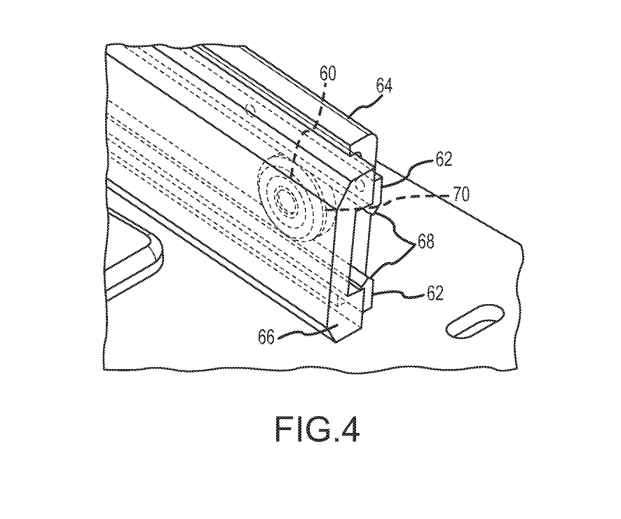

Referring in particular to FIG. 3B, each rail 14, 15 includes a rail extension 56, 58, respectively. The rail extensions 56, 58 may be coupled across the width of the rails by adjustable crossbar 57. Rail extensions 56, 58 are composed of aluminum or steel and may be extendably coupled to the rails 14, 15 in any manner known in the art. For example, referring to FIG. 4, rail 14 and rail extension 56 may be coupled to a track 62 in which one or more guide wheels 60 may move. As shown in FIG. 4, rail 15 includes a first simple U shaped body 64 on which at least one DualVee® washdown bearing guide wheel 60 is mounted. Extension 58 is composed of a second U shaped body 66 coupled to a pair of “Vee” edge tracks 62. Both the “Vee” edge track 62 and the DualVee® guide wheel 60 are manufactured by Bishop-Wisecarver Corporation. The “Vee” Edge tracks 62 are so named for the V shaped protrusions 68 extending into a groove 70 in the DualVee® guide wheel 60. The protrusion 68 engages the groove 70 and the groove 70 directs and guides the extension 58 as the guide wheel 60 rotates and the extension 58 is extended.

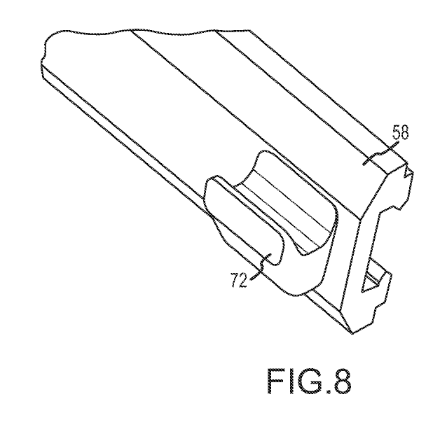

An interface hook 72, best shown in FIG. 8, is coupled to each extension 56, 58. Interface hook 72 engages the support frame 104 of the cot 10, supporting and lifting the cot 10 by the sturdy support frame 104. If desired, a coupling hook 74, such as that shown in FIG. 6 may be fixed to the cot 10 to quickly, securely, and releasably engage the interface hook 72. Additionally, the interface hook 72 may be coupled to the extension 56 or 58 via a hinge or the coupling hook 74 may be fixed to the support frame 104 via a hinge that allows the interface hook 72, the coupling hook 74, or both, to rotate as the lift mechanism 24 is operated.

Interface hook 72 may be coupled to the extension 56, 58 by a length of material such as wire, strapping, or rope. The length of material may couple at a Y shaped joint such that one portion of the interface hook 72 couples to the support frame 104 at the head end 106 and another portion of the interface hook 72 couples to the support frame 104 at the feet end 108 on each side of the support frame 104. The length of the length of material may be adjustable by a winch or other mechanism familiar to one having skill in the art. In this way, the lift mechanism of the invention may be used to assist emergency response personnel to lift the loaded cot from a position very near to the ground. In this embodiment, the loaded cot may be wheeled adjacent to the ambulance while the wheel carriage 102 is at least partially compacted. With the rail extensions 54, 56 extended, the length of material is deployed to allow the interface hook 72 to couple to the cot 10 at some distance from the extension 54, 56. The linear actuator 26 may then be operated to lift the rail extensions 54, 56 relative to the ground, lifting the cot 10 from its lowered position. When the cot is raised sufficiently, the wheel carriage 102 may be fully extended to support the cot 10 as the interface hook 72 is adjusted to be in position to load the cot as described by the method below.

In another embodiment, the interface hook 72 is attached to the rail extension 56 or 58. Interface hook 72 may comprise a body 73 that is extended in the direction of the axis of the rails 14, 15. Body 73 includes a recess 75 and a tapered portion 76. Interface hook 72 conveniently couples with coupling hook 74.

Coupling hook 74 includes a support casing 78 on each side of the support frame 104. Each support casing 78 may be directly coupled to the support frame 104, or may be coupled to a crossmember 80 that is coupled to the support frame 104. The support casings 78 are spaced to align with the interface hooks 72. The interior of the support casing 78 includes a secure support pin 82 spanning the support casing 78 in a direction substantially perpendicular to the axis of the rails 14, 15.

Interface hook 72 may be coupled to the rail extension by a spring pivot 84. Spring pivot 84 biases the interface hook 72 to a position substantially parallel to the rail extensions 54, 56, but allows the tapered end of the interface hook 72 to pivot down to a limited degree. The cot 10 may be coupled to the rail extensions 54, 56 by inserting the interface hook 72 into the support casing 78 of the coupling hook 74. During insertion, the tapered portion 76 of the interface hook 72 engages the support pin 82. The force of further movement of the cot 10 toward the ambulance causes the support pin 82 to push against the tapered portion 76, and the spring pivot 84 allows the coupling hook 72 to pivot down and allow further insertion into the support casing 78 of the coupling hook 74. When the support pin 82 reaches the recess 75, the spring pivot 84 biases the coupling hook 74 back up and the support pin 82 resides within the recess 75, restricting the movement of support pin 82 relative to the rail extensions 54, 56.

The support casing 75 may be substantially continuous about the perimeter, forming a closed cross section. This allows the support casing to restrict the movement of the cot 10 in the event of a rollover accident or other traumatic movement of the ambulance while the cot 10 is being transported. A number of attachment mechanisms exist to couple the cot 10 to the extensions 56, 58, and the description provided above is not meant to limit one having skill in the art to the described embodiment.

The crossmember 80 may span the width 114 of the cot 10 and provide an alternative method of adjusting the lift mechanism of the invention to a variety of cot types and sizes. In this embodiment, the rails 14, 15 are non-adjustable at a width slightly greater than the maximum width of a cot 10. Crossmember 80 has an adjustable length and is coupled to both support casings 75 and coupled to the support frame 104. Extending the crossmember to its maximum length places the support casings in a position corresponding to the position of the interface hook 72. In the case of a cot 10 having the maximum width, the crossmember 80 is merely adjusted to its maximum length and locked in place. In the event of a cot 10 having a smaller width 114 than the maximum width, the fully extended crossmember 80 may snag on blankets or clothing of patients or emergency personnel, or otherwise impede movement about the cot 10 when the cot 10 is not coupled to the rails 14, 15. In this case, the crossmember 80 may be adjusted to allow the support casing 75 to be stowed adjacent to or within the periphery of the support frame 104.

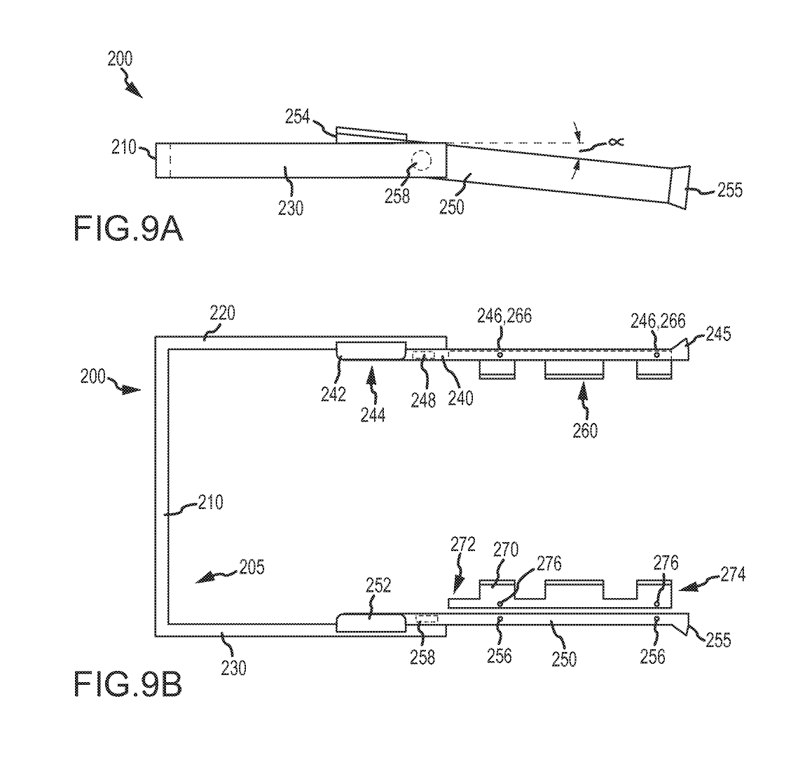

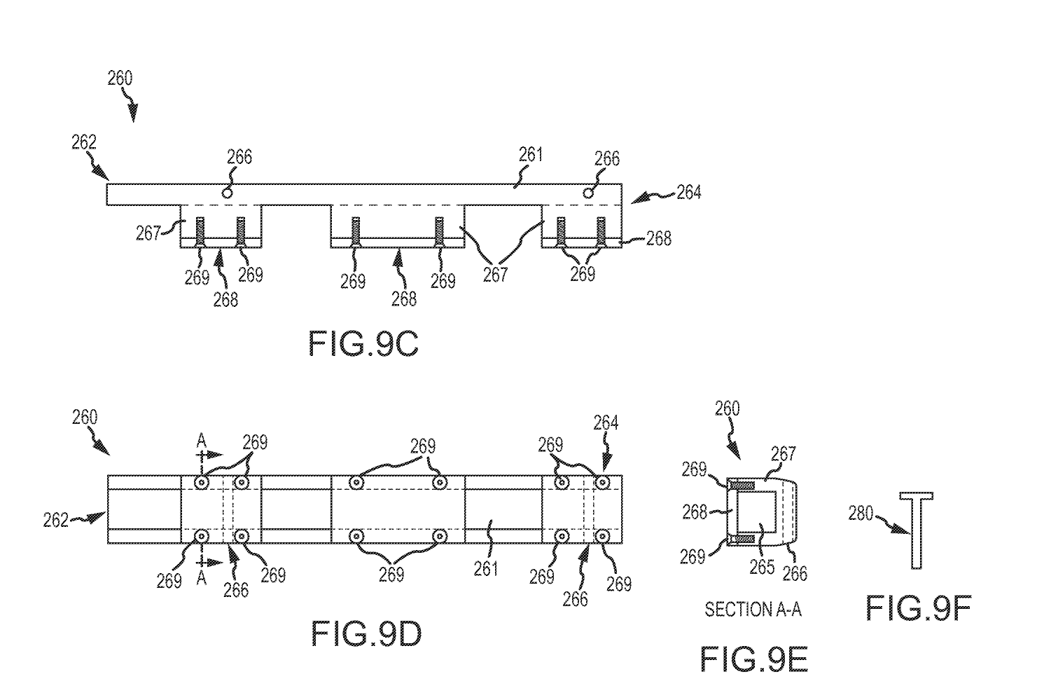

In another embodiment of the invention, as shown in FIGS. 9A-F, the device 1 includes a cot clamp device 200.

FIG. 9A depicts a side view of the cot clamp device 200, with cot clamp device lateral frame 210, cot clamp device left frame 230, cot clamp device left arm 250, cot clamp device left arm proximal lower member 254, cot clamp device left arm flare 255 and cot clamp device frame/arm angle α. Also shown is cot clamp device left pivot 258.

FIG. 9B depicts a top view of the cot clamp device 200, with cot clamp device frame 205, cot clamp device left arm 250 and cot clamp device right arm 240. The cot clamp device frame 205 includes a cot clamp device right frame 220 and cot clamp device left frame 230. The cot clamp device right arm 240 includes a cot clamp device right arm proximal upper member 242, a cot clamp device right arm proximal lower member 244, one or more cot clamp device right arm holes 246 and cot clamp device right arm flare 245. The cot clamp device left arm 250, cot clamp device left arm proximal upper member 252, one or more cot clamp device left arm holes 256 and cot clamp device left arm flare 255. In FIG. 9B, cot clamp device right arm 240 is shown in alignment with cot clamp device right side cot mechanism 260, that is the one or more cot clamp device right side cot mechanism holes 266 are aligned with the one or more cot clamp device right side cot mechanism holes 266. In contrast, cot clamp device left arm 250 is shown unaligned with cot clamp device left side cot mechanism 270, that is the one or more cot clamp device left arm holes 256 are not aligned with the one or more cot clamp device left side cot mechanism holes 276. Also shown is cot clamp device left pivot 258 and cot clamp device right pivot 248.

The cot clamp device 200 pivots, via cot clamp device left pivot 258 and cot clamp device right pivot 248, to form a cot clamp device frame/arm angle α defined by the angle between the cot clamp device left frame 230 and cot clamp device left arm 250. Similarly, cot clamp device 200 pivots to form a cot clamp device frame/arm angle α defined by the angle between the cot clamp device right frame 220 and cot clamp device right arm 240. Although the angle α of FIG. 9A is shown as a positive angle (that is, with the cot clamp device left arm 250 below a horizontal axis with respect to the cot clamp device left frame 230), the angle α may for a negative angle when the cot clamp device left arm 250 moves above a horizontal axis with respect to the cot clamp device left frame 230. One or both of cot clamp device right arm proximal upper member 242 and cot clamp device left arm proximal upper member 252 may be configured to limit angle α to selectable ranges. For example, angle α may be limited to −10 deg to +60 deg, or −60 deg to +10 deg, or −60 deg to +60 deg, or any combination thereof.

In one embodiment, cot clamp device right pivot 248 and/or the cot clamp device left pivot 258 comprise a bearing, a bushing, and any fixing or attachment means known to those skilled in the art to allow pivoting and/or sliding between two mechanical components.

In one embodiment, cot clamp device right pivot 248 and/or the cot clamp device left pivot 258 enable both pivoting and sliding.

In one embodiment, the cot clamp device frame 205 replaces the rail extensions 56 and 58, yet adds the cot clamp device lateral frame 210. For example, cot clamp device right frame 220 replaces and/or serves the function of rail extension 58, and cot clamp device left frame 230 replaces and/or serves the function of rail extension 56, so as to function as described in this disclosure. In another embodiment, the cot clamp device frame 205 supplements the rail extensions 56 and 58 in that the cot clamp device frame 205 is additional structure. In yet another embodiment, the cot clamp device frame 205 partly replaces and partly supplements the rail extensions 56 and 58 and/or the configurations of the rail lift device/system 1 described in this disclosure.

In one embodiment, the cot clamp device lateral frame 210 is manufactured of 6061 aluminum alloy bar stock and of dimension 1 inch by 3 inch 25¾ inch.

In one embodiment, the cot clamp device right frame 220 and cot clamp device left frame 230 are both manufactured of 6061 aluminum alloy bar stock and of dimension 1 inch by 3 inch 23¼ inch.

In one embodiment, the cot clamp device left arm 250 and cot clamp device right arm 240 are both manufactured of 3 inch, 6061 aluminum alloy bar channel stock of length 28¼ inch with ¾ inch inside measure. In one embodiment, the height of either or both of cot clamp device right arm proximal upper member 242 and cot clamp device left arm proximal upper member 252 is 1½ inch or is 1 inch.

In one embodiment, the distance between centerline of each of holes cot clamp device right arm hole 246 as depicted in FIG. 9B is 13½ inch, the distance of the cot clamp device right arm hole 246 located closest to the cot clamp device right arm flare 245 from the end of cot clamp device right arm 240 is 13 7/16 inch and the width (as shown in FIG. 9B) is 1 inch. In one embodiment, the configurations of the one or more cot clamp device right arm holes 246 of the cot clamp device right arm 240 is the same as that of the one or more cot clamp device left arm holes 256 of the cot clamp device left arm 250. In another embodiment, the configurations of the one or more cot clamp device right arm holes 246 of the cot clamp device right arm 240 is not the same as that of the one or more cot clamp device left arm holes 256 of the cot clamp device left arm 250.

In one embodiment, the centerline of the cot clamp device right pivot 248 is positioned at a distance of 22¼ inch from the end of cot clamp device right arm 240 (where end is defined as the end with the arm flare). The cot clamp device right pivot 248 is a bearing of diameter 2 3/16 or 2½ or 3⅞ inch, and is located with a centerline 2 3/16 or 2½ inch below the upper (skyward facing or side as viewed in FIG. 9B) edge of the cot clamp device right arm 240. In one configuration, the cot clamp device left pivot 258 is symmetrically configured with the cot clamp device right pivot 248.

In one embodiment, the cot clamp device left arm 250 and the cot clamp device right arm 240 are both manufactured of 6061 aluminum alloy bar stock. In one embodiment, the cot clamp device left arm 250 and the cot clamp device right arm 240 are both configured to form a ⅝ inch groove.

In one embodiment, both the cot clamp device right arm proximal upper member 242 and the cot clamp device left arm proximal upper member 252 are manufactured of 6061 aluminum alloy bar stock and of dimension ½ inch by 3 inch by 23¼ inch.

In one embodiment, both the cot clamp device right arm flare 245 and cot clamp device left arm flare 255 are ¼ aluminum flares.

FIGS. 9C-E provide a three-view of the cot clamp device right side cot mechanism 260. FIG. 9C provides a top-view of the cot clamp device right side cot mechanism 260. FIG. 9D provides a side-view of the cot clamp device right side cot mechanism 260. FIG. 9E provides a cross-sectional view of the cot clamp device right side cot mechanism 260 along section A-A of FIG. 9D.

In FIGS. 9C-E, cot clamp device right side cot mechanism 260 is depicted with cot clamp device right side cot mechanism arm 261, cot clamp device right side cot mechanism proximal end 262 and cot clamp device right side cot mechanism distal end 264. The cot clamp device right side cot mechanism 260 is fitted with one or more cot clamp device right side cot mechanism holes 266; in FIGS. 9C-E there are two clamp device right side cot mechanism holes 266. The cot clamp device right side cot mechanism 260 is fitted with one or more cot clamp device right side cot mechanism bodies 267, each of which comprise a cot clamp device right side cot mechanism body face 268 and cot clamp device right side cot mechanism hole 266. In FIGS. 9C-E, cot clamp device right side cot mechanism 260 is depicted with three sets of cot clamp device right side cot mechanism bodies 267, cot clamp device right side cot mechanism body face 268, cot clamp device right side cot mechanism cavities 265 and cot clamp device right side cot mechanism hole 266. The cot clamp device right side cot mechanism 260 is fitted with one or more cot clamp device right side cot mechanism attachments 269. In FIGS. 9C-E, each cot clamp device right side cot mechanism 260 is depicted with four cot clamp device right side cot mechanism attachments 269, each configured as a bolt.

In one embodiment, the cot clamp device 200 engages with rail extensions 56 and 58. For example, in one embodiment the cot clamp device right frame 220 engages with the rail extension 58 and the cot clamp device left frame 230 engages with the rail extension 56. The cot clamp device right frame 220 and left frame 230 may engage the respective rail extensions 58 and 56 in any number of ways, to include with a press fit, an interference fit, glues, adhesives, bolts and may engage so as to remain substantially parallel. In one embodiment, the cot clamp device frame 205 is of smaller dimension so as to fit within the interior space defined by the two rail extensions 58 and 56.

In another embodiment, the cot clamp device right arm 240 and the cot clamp device left arm 250 substantially and/or completely replace the respective rail extensions 58 and 56 respectfully.

In one embodiment, the cot clamp device right side cot mechanism arm 261 is manufactured of 6061 aluminum alloy bar stock and of dimension 2½ inch by 19¼ inch by ¾ inch. In one embodiment, the cot clamp device left side cot mechanism arm 271 (not shown) is manufactured of 6061 aluminum alloy bar stock and of dimension 2½ inch by 19¼ inch by ¾ inch.

In another embodiment, any of the aforementioned bar stocks could instead be any bar stock between and including ¼ to ¾ inch bar stock.

In one embodiment, the cot clamp device right side cot mechanism body 267 is fitted with the cot clamp device right side cot mechanism body face 268 such that the cot clamp device right side cot mechanism body 267 is of dimension ¼ inch by ½ inch by 3 inch and the cot clamp device right side cot mechanism body face 268 is of dimension 2½ by 3 inch by ⅜ inch. In one embodiment, one or more of the cot clamp device right side cot mechanism body 267 and the cot clamp device right side cot mechanism body face 268 are manufactured from 6061 aluminum alloy bar stock.

In another embodiment, the cot clamp device right side cot mechanism body 267 is fitted with the cot clamp device right side cot mechanism body face 268 such that the cot clamp device right side cot mechanism body 267 is of dimension 1¼ inch by ½ inch by 5 inch and the cot clamp device right side cot mechanism body face 268 is of dimension 2½ by 5 inch by ⅜ inch. In one embodiment, one or more of the cot clamp device right side cot mechanism body 267 and the cot clamp device right side cot mechanism body face 268 are manufactured from 6061 aluminum alloy bar stock.

In one embodiment, the cot clamp device left side cot mechanism body 277 is fitted with the cot clamp device left side cot mechanism body face 278 such that cot clamp device left side cot mechanism body 277 is of dimension ¼ inch by ½ inch by 3 inch and the cot clamp device left side cot mechanism body face 278 is of dimension 2½ by 3 inch by ⅜ inch. In one embodiment, one or more of the cot clamp device left side cot mechanism body 277 and the cot clamp device left side cot mechanism body face 278 are manufactured from 6061 aluminum alloy bar stock.

In another embodiment, the cot clamp device left side cot mechanism body 277 is fitted with the cot clamp device left side cot mechanism body face 278 such that cot clamp device left side cot mechanism body 277 is of dimension 1¼ inch by ½ inch by 5 inch and the cot clamp device left side cot mechanism body face 278 is of dimension 2½ by 5 inch by ⅜ inch. In one embodiment, one or more of the cot clamp device left side cot mechanism body 277 and the cot clamp device left side cot mechanism body face 278 are manufactured from 6061 aluminum alloy bar stock.

In one embodiment, the cot clamp device right side cot mechanism attachment 269 is a ¼20 by 1 inch flat head bolt. In one embodiment, the cot clamp device left side cot mechanism attachment 279 (not shown) is a ¼20 by 1 inch flat head bolt.

FIG. 9F depicts a cot clamp device pin 280. The cot clamp device pin 280 is configured for insertion into the one or more cot clamp device right arm holes 246, the cot clamp device left arm holes 256, the one or more cot clamp device right side cot mechanism holes 266 and the one or more cot clamp device left side cot mechanism holes 276. In FIG. 9F, the cot clamp device pin 280 is configured as a pin with substantially perpendicular head.

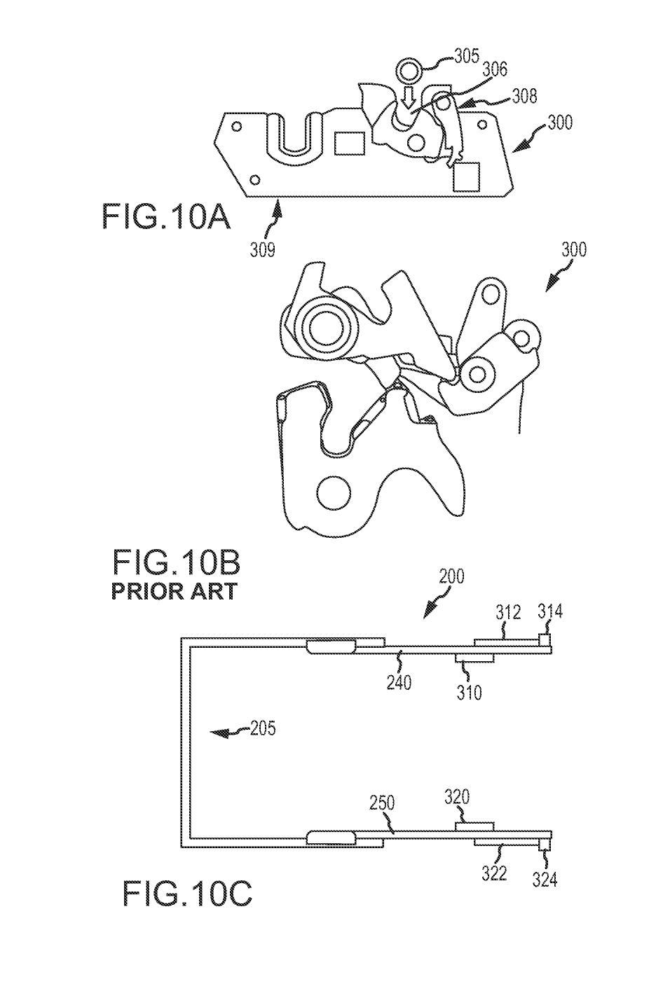

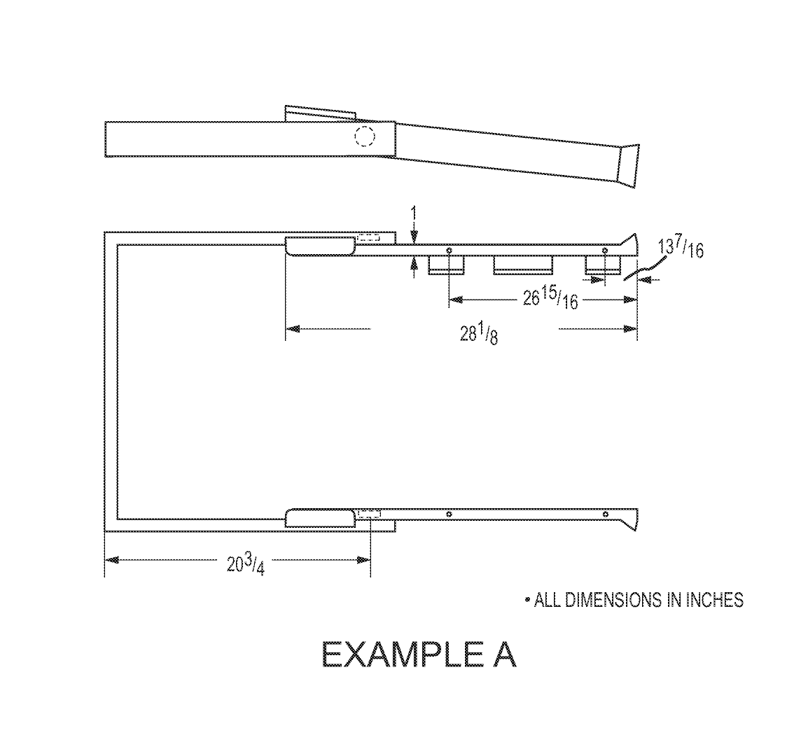

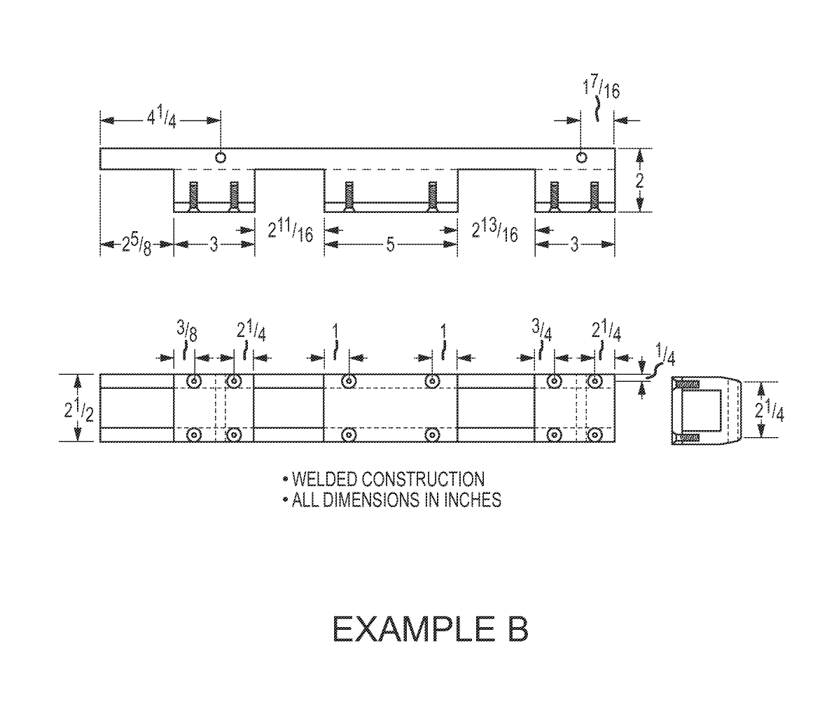

FIG. 10A depicts a side view of an alternate embodiment of the cot clamp device mechanism of an alternate embodiment of the cot clamp device 200. FIG. 10A depicts a door latch 300 comprising door striker receiving cavity 306, door latch receiving mechanism 308 and door latch mounting plate 309. The door latch 300 engages a door striker 305, as the door striker 305 moves in the direction shown and/or the door latch 300 moves in the opposite direction of the arrow, such that the door striker 305 enters the door striker receiving cavity 306 so as to engage the door latch receiving mechanism 308.

FIG. 10B depicts a side view of a vehicle door latch 300 of the prior art.

FIG. 10C depicts a top view of an alternate embodiment of the cot clamp device 200. The cot clamp device 200 of FIG. 10C is broadly similar to that of FIGS. 9A-B, except that each of the cot clamp device right side cot mechanism 260, cot clamp device left side cot mechanism 270 and cot clamp device pin 280 have been replaced with a door latch 300 and door striker 305 on one or both of cot clamp device left arm 250 and cot clamp device right arm 240. More specifically, in the embodiment of FIG. 10C, cot clamp device right arm 240 comprises a cot clamp latch right side 310, cot clamp latch right side wire 312 and cot clamp latch right side handle 314. Similarly, cot clamp device left arm 250 comprises a cot clamp latch left side 320, cot clamp latch left side wire 322 and cot clamp latch right side handle 324. A door striker 305 (not shown in FIG. 10C) would be fitted to a cot 10 (not shown in FIG. 10C) so as to engage one or more of cot clamp latch right side 310 and cot clamp latch left side 320. The door striker 305 engages any of the cot clamp latch right side 310 and/or cot clamp latch left side 320 in a similar manner to that described for FIG. 10A. However, the cot clamp latches 310, 320 are adapted to be oriented substantially perpendicularly to the respective cot clamp device right arm 240 and cot clamp device left arm 250, and the respective door strikers 305 are fitted to the cot 10 approximately at the location of the coupling hook 74 of the cot 10 of FIG. 6. When the door strikers 305 engage any of the cot clamp latch right side 310 and/or cot clamp latch left side 320, the cot 10 is secured to the cot clamp device 200.

To disengage the door strikers 305, cot clamp latch handles 314,324 are engaged/pulled/lifted so as to communicate via cot clamp wires 312, 322 so as to disengage the one or more door strikers 305 with the one or more of cot clamp latch right side 310 and cot clamp latch left side 320.

Although the cot clamp wires 312, 322 are depicted in FIG. 10C in a particular configuration, i.e. mounted exterior to the cot clamp device left arm 250 and cot clamp device right arm 240, the cot clamp wires 312, 322 may be mounted primarily interior of the cot clamp device left arm 250 and cot clamp device right arm 240 or some combination thereof. Similarly, the location of the door strikers 305 may be any location along the rim or outside of the cot 10 or any position reasonable to one skilled in the art. Also, the cot clamp wires 312, 322 may be fabricated of any cable or push/pull mechanism known to one skilled in the art. Also, the cot clamp latch right side 310 and cot clamp latch left side 320 may be configured so as to be linked in that engaging one of the respective cot clamp latch right side handle 314 or cot clamp latch left side handle 324, the other respective latch is engaged so as to disengage the cot 10 from the cot clamp device 200 and thus the rail lift device/system 1.

In another embodiment of the invention, a method of unloading a cot 10 from an ambulance and loading the cot 10 into the ambulance with or without a patient on the cot 10 is provided. In this embodiment, a cot 10 is provided, the cot having a support frame 104, a head end 106, a foldable wheel carriage 102, and load wheels 110 beneath the head end 106 of the support frame 104. The support frame 104 has a peripheral width 114 that is wide enough to support an obese patient, but narrow enough to fit into the ambulance.

The cot 10 is loaded and unloaded into the ambulance by a rail lift device 1. Rail extensions 56, 58 are detachably coupled to the support frame 104 on each side of the support frame 104, respectively. The rail extensions 56, 58 may have manufactured, fixed dimensions to accommodate a standard ambulance cot 10 or may be adjusted to fit the support frame 104 of the cot 10 of a particular ambulance after installation of the rail lift device 1 and prior to loading the cot 10 in the ambulance. The device 1 may be adjusted to fit the particular model of cot 10 used in a given ambulance prior to, or after installation of the device 1 in the ambulance.

To adjust the device 1 to fit a particular cot 10, the adjusting nut 46 and base adjustment nut 54 are loosened and the brace 22 and legs 16, 17 described above are set at a width greater than the peripheral width 114 of the cot 10. The extensions 56, 58 are fully extended and the cot 10 to be fitted is placed in position between the extensions 56, 58. The legs 16, 17 are made narrower until the interface hook 72 is in position to couple to the support frame 104 or the coupling hook 74. The width of the brace is also adjusted such that the extensions 56, 58 and the rails 14, 16 are substantially parallel. The widths of the legs 16, 17 and the brace 22 are then secured in place by tightening the adjustment nut 46 and the base adjustment nut 54.

To deploy the cot 10, the user simply pulls the cot 10 out of the ambulance using essentially the same procedure as is currently employed to manually unload a cot 10 from an ambulance. The support frame 104 coupled to the extensions 56, 58 by the interface hooks 72 pulls the extensions 56, 58 into an extended position as shown in FIG. 3B as the cot 10 is unloaded. Alternatively, the cot may be extended from the ambulance by a mechanized piston or other mechanism familiar to one having skill in the art. When the cot 10 is deployed such that the wheel carriage 102 is clear of the ambulance, the wheel carriage 102 is unfolded into a fully extended position.

With the wheel carriage extended, the user activates the lift mechanism 24. The motor 28 of the lift mechanism 24 may be activated by a button or switch (not shown). The motor 28 extends the linear actuator 26 to lift the brace 22. The rails 14, 16 pivot about the axle 19 and the extensions 56, 58 are lowered toward the ground as shown in FIG. 3C. The lowered rail extensions concurrently lower the wheel carriage 102 into contact with the ground. With the cot supported by the ground and the load wheels 110, the interface hooks 72 are detached from the support frame 104 or the coupling hooks 74. The cot may then be deployed where it is needed. The device 1 may be withdrawn back into the ambulance as shown in FIGS. 3D-E, or left in place to receive the loaded cot 10 for loading.

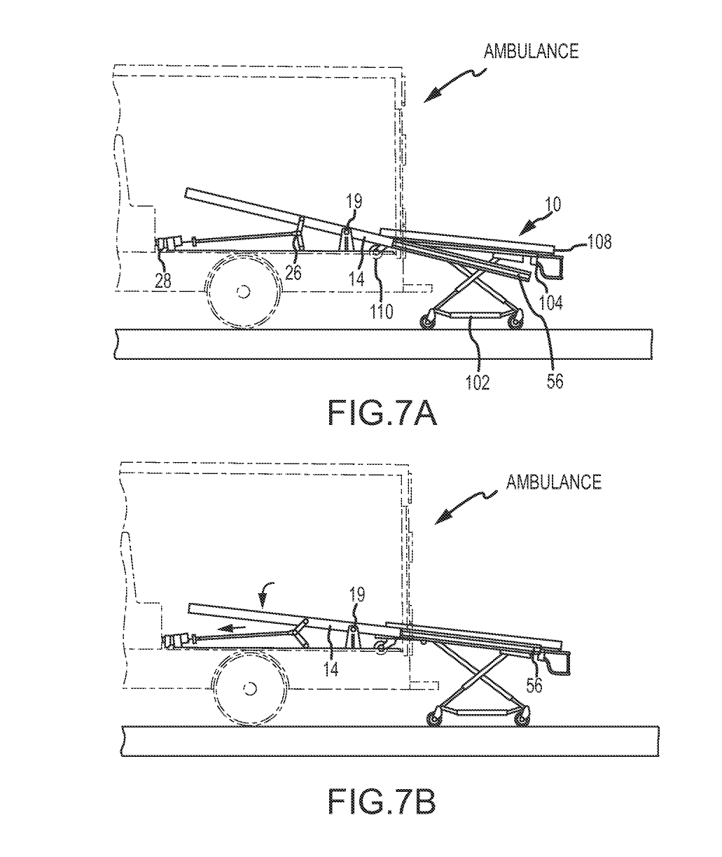

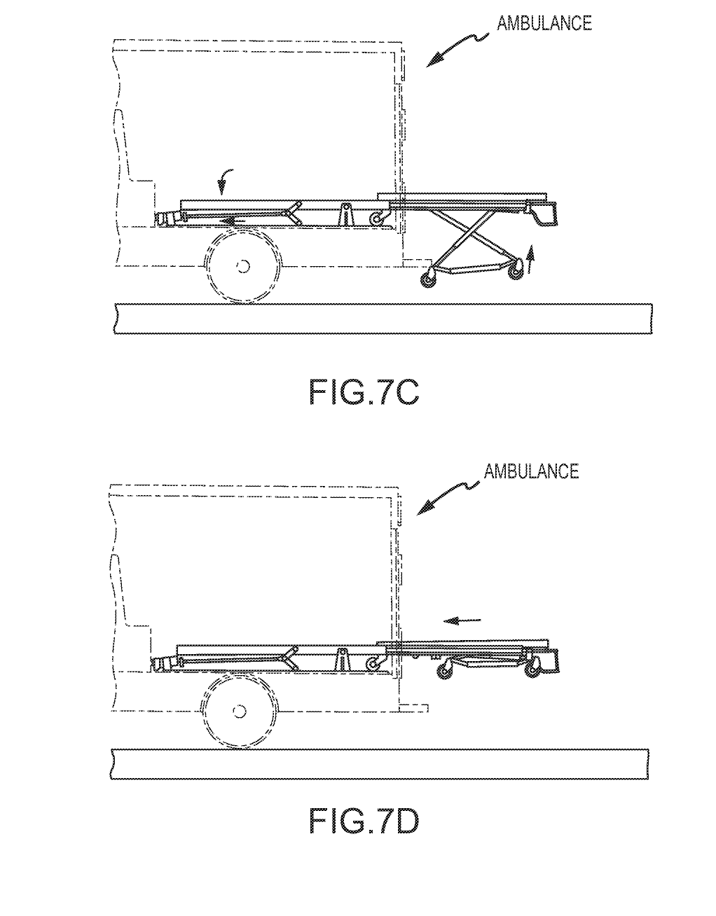

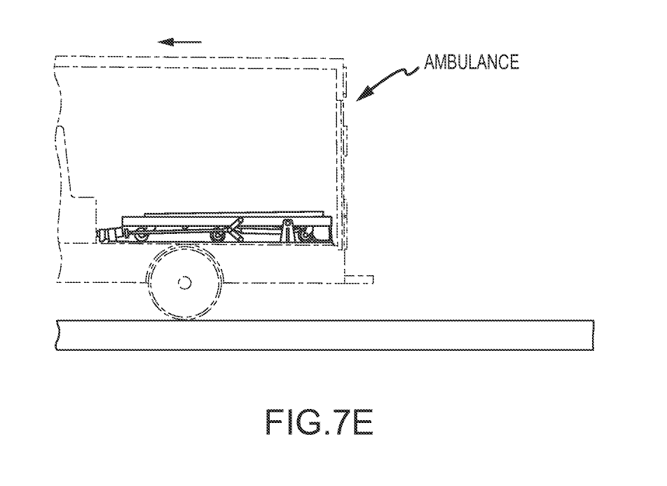

To load the cot 10 back into the ambulance with the patient on board, the inhabited cot 10 is transported to the entrance to the ambulance and the load wheels 110 are placed on the interior floor of the ambulance to support at least a portion of the weight of the inhabited cot 10 as shown, for example, in FIG. 7A. The interface hooks 72 are then attached to the support frame 104 or coupling hooks 74, in one embodiment simply by retracting the linear actuator 26 to lift the extensions 56, 58 as is shown in FIG. 7B.

In one embodiment of the device 1 when configured with the cot clamp device 200 of FIGS. 9A-F, the one or more cot clamp device right side cot mechanism holes 266 of the cot clamp device right side cot mechanism 260 and the one or more cot clamp device left side cot mechanism holes 276 of the cot clamp device left side cot mechanism 270 are aligned with the respective one or more holes 246 of the cot clamp device right arm 240 and the one or more holes 256 of the cot clamp device left arm 230, and one or more 280 are inserted into the respective aligned holes. In this manner, the cot 10, now secured to the cot clamp device left arm 230 and cot clamp device right arm 240, is secured to the cot clamp device 200 which in turn is secured to the device 1.

In one embodiment of the device 1 when configured with the cot clamp device 200 of FIG. 10C, the one or more door strikers 305 fitted to cot 10 would engage one or more of cot clamp latch right side 310 and cot clamp latch left side 320. (Cot clamp latch handles 314,324 when engaged/pulled/lifted communicate via cot clamp wires 312, 322 so as to disengage the one or more door strikers 305 with the one or more of cot clamp latch right side 310 and cot clamp latch left side 320). In this manner, the cot 10, now secured to the cot clamp device left arm 230 and cot clamp device right arm 240, is secured to the cot clamp device 200 which in turn is secured to the device 1.

The motor 28 of the lift mechanism 24 is activated to operate in the opposite direction when the button or switch is again deployed by the user. The motor 28 smoothly retracts the linear actuator 26, pulling the brace 22 toward the interior floor of the ambulance. The extended rails 14, 16 pivot about the axle 19 to lift the extensions 56, 58 and the support frame 104 coupled between the extensions 56, 58.

The cot 10 may be lifted completely off the ground with the entire weight of the cot 10 supported by the ambulance and the transport patient lift system 1 by fully retracting the linear actuator 26 as shown in FIG. 7C. When the linear actuator 26 is fully retracted and the rails 14, 16 and extensions 56, 58 are substantially parallel to the interior floor of the ambulance, the cot 10 may be pushed on the load wheels 110 and the wheel carriage 104 until the cot 10 is completely inside the ambulance and the head portion 106 of the support frame 104 is securely accommodated in the brace 22. The cot may then be secured to the ambulance by locking the linear actuator 26 in place, or by any other suitable method and the patient transported to receive further care as shown in FIG. 7E.

Although the preceding detailed description has provided several embodiments of a lift mechanism, alternatives are possible without departing substantially from the spirit and principles of the invention. For example, the device may be used to lift any heavy load having a support frame into a transport vehicle. Also, the lift mechanism may be actuated at the feet end of the cot, rather than at the head end of the cot, or may be coupled to the support frame using a strap or other lifting mechanism. Further, the device and method may be altered to a wheeled apparatus used to transfer a patient from one bed to another on a stretcher within a hospital or other institution involved in moving people. All such modifications and variations are intended to be included herein within the scope of this disclosure and the present invention and protected by the following claims.

To provide further clarity to the Detailed Description provided herein in the associated drawings, the following list of components and associated numbering are provided as follows:

| Reference | |
|---|---|
| Number | Component |
| 1 | rail lift device/system |
| 10 | cot |
| 12 | base plate |
| 14 | first straight rail |
| 15 | Second straight rail |
| 16 | legs |
| 17 | legs |
| 19 | axle |
| 20 | closed end |
| 21 | stabilizer |
| 22 | brace |
| 24 | lift mechanism |
| 26 | linear actuator |
| 28 | motor |
| 30 | hinge |
| 32 | first plate |
| 34 | second plate |
| 36 | third plate |
| 38 | vertical portion |
| 40 | horizontal portion |
| 42 | slot |
| 43 | adjustment support |
| 44 | bolt |
| 45 | base slots |
| 46 | adjusting nut |
| 47 | base slots |
| 50 | holes |
| 52 | Base bolts |
| 54 | base adjustment nut |
| 56 | Rail extension |
| 57 | adjustable crossbar |
| 58 | Rail extension |
| 60 | DualVee ® guide wheel |
| 62 | track |
| 64 | first simple U shaped body |
| 66 | second U shaped body |
| 68 | V shaped protrusions |
| 70 | groove |
| 72 | interface hook |
| 73 | body |
| 74 | coupling hook |
| 75 | recess |
| 76 | tapered portion |
| 78 | support casing |
| 80 | crossmember |
| 82 | secure support pin |
| 84 | spring pivot |
| 102 | wheel carriage |
| 104 | support frame |
| 106 | head end |
| 108 | feet end |
| 110 | load wheels |
| 114 | width |
| 200 | cot clamp device |
| 205 | cot clamp device frame |
| 210 | cot clamp device lateral frame |
| 220 | cot clamp device right frame |
| 230 | cot clamp device left frame |
| 240 | cot clamp device right arm |
| 242 | cot clamp device right arm proximal upper member |
| 244 | cot clamp device right arm proximal lower member |
| 245 | cot clamp device right arm flare |
| 246 | cot clamp device right arm hole |
| 248 | cot clamp device right pivot |
| 250 | cot clamp device left arm |
| 252 | cot clamp device left arm proximal upper member |
| 254 | cot clamp device left arm proximal lower member |
| 255 | cot clamp device left arm flare |
| 256 | cot clamp device left arm hole |
| 258 | cot clamp device left pivot |
| 260 | cot clamp device right side cot mechanism |
| 261 | cot clamp device right side cot mechanism arm |
| 262 | cot clamp device right side cot mechanism proximal end |
| 264 | cot clamp device right side cot mechanism distal end |
| 265 | cot clamp device right side cot mechanism cavity |
| 266 | cot clamp device right side cot mechanism hole |
| 267 | cot clamp device right side cot mechanism body |
| 268 | cot clamp device right side cot mechanism body face |
| 269 | cot clamp device right side cot mechanism attachment |
| 270 | cot clamp device left side cot mechanism |
| 271 | cot clamp device leftt side cot mechanism arm |
| 272 | cot clamp device left side cot mechanism proximal end |
| 274 | cot clamp device left side cot mechanism distal end |
| 276 | cot clamp device left side cot mechanism hole |
| 277 | cot clamp device left side cot mechanism body |
| 278 | cot clamp device left side cot mechanism body face |
| 279 | cot clamp device left side cot mechanism attachment |
| 280 | cot clamp device pin |
| 300 | door latch |
| 305 | door striker |
| 306 | door striker receiving cavity |
| 308 | door latch receiving mechanism |
| 309 | door latch mounting plate |
| 310 | cot clamp latch right side |
| 312 | cot clamp latch right side wire |
| 314 | cot clamp latch right side handle |
| 320 | cot clamp latch left side |
| 322 | cot clamp latch left side wire |
| 324 | cot clamp latch left side handle |
| α | cot clamp device frame/arm angle |

While various embodiment of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

### EXAMPLES

Without intending to limit the scope of the invention, Examples A and B illustrates how various embodiments of the invention may be made and/or used.

We claim:

1. A lift system for use in loading a cot into and unloading a cot from an interior of an ambulance, the cot having a head end, at least one load wheel, and a support frame, the system comprising:
a first rail coupled to the ambulance by a brace and further coupled to the ambulance at a first axle, wherein the first rail pivots at the first axle;
a linear actuator coupled to the ambulance and to the brace, wherein the linear actuator has a length and is configured to mechanically vary the length of the linear actuator;
a first extension coupled to the first rail such that the first extension may move axially relative to the first rail;
the first extension including a cot clamp device, the cot clamp device configured to detachably couple to the support frame such that when the cot clamp device is coupled to the support frame the cot clamp device and the support frame are of substantially fixed relative distance, wherein activation of the linear actuator pivots the extension to support at least a portion of the weight of the cot.

2. The lift system of claim 1, further comprising:
a second rail coupled to the ambulance at a second brace and a second axle, a second extension coupled to the second rail such that the second extension may move axially relative to the second rail and extend beyond the interior of the ambulance; a second interface coupled to the second extension that may be detachably coupled to the support frame substantially opposite to the cot clamping device.

3. The lift system of claim 1, wherein the linear actuator is a motorized winch.

4. The lift system of claim 1, wherein the interior of the ambulance has a load end and a cab end opposite the load end and wherein the linear actuator is fixedly coupled to the interior of the ambulance adjacent to the cab end.

5. The lift system of claim 2, wherein the first brace and the second brace comprise a single structure.

6. The lift system of claim 2, wherein the first axle and the second axle comprise a single structure.

7. The lift system of claim 2, wherein the second rail is separated from the first rail by a distance, and wherein the distance is adjustable.

8. The lift system of claim 1, wherein the first brace is shaped to accommodate a portion of the support frame of the cot.

9. The lift system of claim 1, wherein the cot clamping device is shaped to define at least a partial sleeve of a portion of the support frame.

10. The lift system of claim 2, wherein the first rail is substantially parallel to the second rail and further comprising a base plate fixedly coupled to the ambulance and coupled to at least one axle wherein the position of the at least one axle relative to the base plate is adjustable in a position that is substantially perpendicular to first rail and the second rail.

11. The lift system of claim 2, further comprising a first leg between the first rail and the first axle, and a second leg between the second rail and the second axle.

12. A method of lifting a load on a transport into and out of a vehicle having an interior floor at a height, the transport having a carriage and a support frame, the method comprising:
providing at least one extendable rail having a first end, a cot clamp device and a second end substantially enclosed in the vehicle;
coupling the rail to the interior of the vehicle at a brace located at the first end and at an axle;
extending the rail outside of the vehicle;
allowing the brace to pivot the rail about the axle, bringing the second end of the rail in closer proximity to the transport;
coupling the cot clamp device to the support frame of the transport;
securing the cot clamping device to the support frame of the transport;
moving the brace to pivot about the rail while the cot clamping device is coupled to the support frame of the transport sufficiently to raise the carriage of the transport to the height of the interior floor of the vehicle; and
laterally manipulating the transport into the vehicle.

13. The method of claim 12, wherein the support frame has a peripheral width and the at least one extendable rails provided includes a first extendable rail and a second extendable rail separated by a rail width.

14. The method of claim 13, further comprising the step of adjusting the rail width to substantially equal the peripheral width of the support frame.

15. The method of claim 13, wherein the support frame of the transport is more narrow than the rail width and is provided with at least one cot clamp device arm adjacent to each side of the support frame and an adjustable length crossmember coupling at least one of cot clamp device arms to the support frame the method further comprising adjusting the crossmember such that the distance between the cot clamp device arms corresponds to the rail width.

16. A lift system for use in loading a cot into and unloading a cot from an interior of an ambulance, the cot having a head end, at least one load wheel, a cot clamp device cot mechanism, at least one cot clamp device cot mechanism hole and a support frame, the system comprising:
a first rail coupled to the ambulance by a brace and further coupled to the ambulance at a first axle, wherein the first rail pivots at the first axle;
a second rail coupled to the ambulance at a second brace and a second axle, a second extension coupled to the second rail such that the second extension may move axially relative to the second rail and extend beyond the interior of the ambulance;
a linear actuator coupled to the ambulance and to the brace, wherein the linear actuator has a length and is configured to mechanically vary the length of the linear actuator, wherein the linear actuator is a motorized winch;
a first extension coupled to the first rail such that the first extension may move axially relative to the first rail;
the first extension including a cot clamp device, the cot clamp device including a first cot clamp device arm, the first cot clamp device arm configured to pivot with respect to the first extension and configured with at least one hole, the first cot clamp device arm configured to detachably couple to the at least one cot clamp device cot mechanism hole by alignment of the at least one hole of the first cot clamp device arm with the at least one cot clamp device cot mechanism hole and insertion of a cot clamp device pin therein, such that when the cot clamp device is coupled to the support frame the cot clamp device and the support frame are of substantially fixed relative distance, wherein activation of the linear actuator pivots the extension to support at least a portion of the weight of the cot.

17. The lift system of claim 16, wherein the first cot clamp device arm is configured to slide with respect to the first extension.

18. The lift system of claim 17, wherein the interior of the ambulance has a load end and a cab end opposite the load end and wherein the linear actuator is fixedly coupled to the interior of the ambulance adjacent to the cab end.

19. The lift system of claim 18, wherein the first brace and the second brace comprise a single structure.

20. The lift system of claim 16, wherein the first axle and the second axle comprise a single structure.
